(19) United States
(12) Patent Application Publication
(10) Pub. No.: US 2010/0258411 A1
(43) Pub. Date: Oct. 14, 2010

(54) Intelligent Conveyor Adjustment System

(75) Inventors: Simon Thomas, Norwood, MA (US); Paul Thomas, Medfield, MA (US); David Thomas, Norwood, MA (US)

Correspondence Address: Paul Thomas, 355 Providence Hwy, Westwood, MA, 02090, US

(73) Assignee: A. S. Thomas Inc., Westwood, MA (US)

(21) Appl. No.: 12/754,314

(22) Filed: Apr. 5, 2010

Related U.S. Application Data
(60) Provisional application No. 61/211,840, filed on Apr. 3, 2009.

(51) Int. Cl. B65G 43/00

(52) U.S. Cl. 198/866

(57) ABSTRACT

The invention is an Intelligent Conveyor Adjustment System (ICAS). The ICAS gives the user a way to adjust guide rails and other devices used in a conveyor system with actuators that can receive instructions based on a specific communications interface, such an interface may consist of but is not limited to serial wired network, an 802.11 compatible network, a power line network, and as described in the examples a wireless network, in a fashion to position rails or other devices on a conveyor system or in machines associated with a conveyor system. The actuators can be but are not limited to varying types, linear, rotary, push/pull covered cable, flexible strips, lever, pivoting, scissor, or other dual actuating mechanisms. The ACMs are used to control the actuators which control the relative position and shape of guide rails on the sides of the conveyor as well as position of various other conveyor entities such as, but not limited to, timing screws, labelers, marking machines, barcode readers, and fillers.

### BACKGROUND OF THE INVENTION

1. Field of Invention

This invention relates generally to industrial equipment lines and, more particularly, to a control system and method for controlling the properties of a conveyor line using a network of actuators capable of hierarchical and peer-to-peer communication. The first application of this is in packaging lines for equipment change-overs utilizing a wireless network. This is just one of the many possible applications for the system and network type.

2. Description of Related Art

Modern industrial conveying equipment for the packaging of products, such as beverages and dry goods, uses a series of manual adjusters distributed along the conveyor to adjust the rail aperture to the package width or diameter. The adjusters control properties over the length of the conveyor rail or where needed. Other equipment on the line may also be adjusted when a different product is to be processed by the packaging line. Some of these machines can be adjusted automatically but many have adjustments that are done by hand. They may have height or width, adjustments needed or as in many they have hand cranks that need to be dialed in. The operator or plant crew needs to adjust these cranks or screws to a predefined location.

Typically, conveyor rail system adjustment is performed manually by workers performing basic rail adjustment in accordance with written instructions and the use of an artifact to determine the aperture. In some systems, the aperture is realized by the placement of a spacer or the positioning of a cam to a predetermined set point.

However, there is little overall coordination of all the conveyor system (CS) actuators controlling all the various property profiles such as rail aperture, timing screw aperture and height, and active equipment freeboard.

U.S. Pat. No. 6,578,702 B2, describes a control system and method with a network of actuators in a conveyor rail system that communicates control information to a central control system and is connected to it via discrete control cables.

However, this system uses a bus or cable to facilitate communication in the network. This causes a significant manpower need for installation, maintenance and troubleshooting. Additionally, there is a significant cost for the installation.

Accordingly, there is a need to reduce the cost and simplify the maintenance for the conveyor rail system and to integrate this with other machines on the line. These other machines can have similar actuators controlled by the same system so that they will not need to be either manually adjusted or adjusted by their own HMI.

### BRIEF SUMMARY OF THE INVENTION

Applicant has developed a network neutral cross-directional actuator and control system. The system may utilize several different network methods as are appropriate to the specific installation.

The invention overcomes many of the drawbacks of the prior art by eliminating a need for a physical communication cable to be attached and connected to each of the plurality of actuators in the network. By developing wireless and power connection interfaces the need for dedicated communication cabling can be eliminated. The invention also needs to have the proper actuators for the various operations that might be needed in a change-overs. These actuators can be varying types but not limited to; linear, rotary, push/pull covered cable, push/pull flexible strips or geared flexible strips, lever, pivoting, scissor, or other dual actuating. The one system can control these various actuators with various instructions at the desired time.

Accordingly, disclosed is an Intelligent Conveyor Adjustment System (ICAS) having a for example a wireless radio transceiver, a controller and a memory section. The wireless radio transceiver is used for transmitting and receiving control and functional information to and from ICAS Segment Coordinators (SC). The SC is used for processing the received control and functional information and for outputting a control command to a Actuator Control Module (ACM) based upon the received control and functional information. Control and functional information, the sequencing algorithm, a unique communications identifier for each of the ACM's, and its own unique communications identifier are stored in the memory section. Each ACM is assigned a unique identification. The unique identifier is used to route information to and from SC's. Each ACM is capable of communication with all other ACMs within an actuator network.

The SC memory section includes a database of all of the ACMs, within the actuator segment network, its corresponding unique communication identifier, and its corresponding position in the segment.

Each ACM is capable of communication with all other ACMs within the conveyor system. The ACMs are used to control the relative position and shape of guide rails on the sides of the conveyor as well as position of various other conveyor entities such as, but not limited to, timing screws, labelers, marking machines, barcode readers, and fillers. The ACM can also control another actuator or actuators which would be an ICAS Secondary Actuator (SA), so therefore they could be used in pairs(triplets quads . . . ) but still perform separate movements of a Master and Secondary Actuator (ICAS ACM or SA). They could be used as opposing actuators controlling the width and location of the guide rails above the conveyor. They also could be used as independent actuators on the same side of the conveyor as consecutive actuators controlling the location and shape of the guide rail. Or they could control two axis of the location of a timing screw, in fact a ACM and three (3) SA's could position both ends of a timing screw or some other device on a conveyor system. Similarly the ACMs could have a rotary motion as their actuation motion. This could be used to move a cam or a gear or some other device that needs a rotary action. The rotary ACM could be attached to a housed push/pull cable or a strap or pulley and could also transmit the rotary motion from it and could be used to turn a device, a cam, or a gear that is used to move or control a device on the conveyor system. Note: the actuators can be moved in any axis or angle and even have an actuator that has control of more than one axis. The actuators can be move simultaneously, individually, in parallel, or in a coordinated motion such as in a “zipper” type motion.

The ACM also includes a timer or a timing means that is set to a predetermined threshold value. The predetermined threshold value is based upon a time that the ACM expects to receive control and functional information from the SC. The timer is used as a warning device that can provide notice to other ACMs that a wireless transceiver has malfunctioned.

If the timing means expires without receiving control and functional information from the SC, the ICAS ACM, corresponding to the expired timer or timing means, will annunciate the failure mode by flashing a subset of the LED array at a specified rate and broadcast a status inquiry to the at least one neighboring SC. If a response to the status inquiry is not received, subsequently, then the ACM will transmit a communications error message to the other ACMs.

Control and functional information in the actuator network is prioritized and routed based upon a location of an originating ACM. Additionally, error messages are given a higher priority than other periodic control and status messages.

### BRIEF DESCRIPTION OF THE DRAWINGS

These and other features, benefits and advantages of the present invention will become apparent by reference to the following text and figures, with like reference numbers referring to like elements across the views, wherein:

FIG. 1 illustrates a block diagram of control and transmission portions of a ICAS ACM according to one embodiment of the present invention;

FIG. 2 illustrates an example of an industrial conveyor rail system with the ICAS ACMs according to the present invention; and

FIG. 3 illustrates three ICAS ACMs according to one embodiment of the invention.

### DETAILED DESCRIPTION OF THE INVENTION

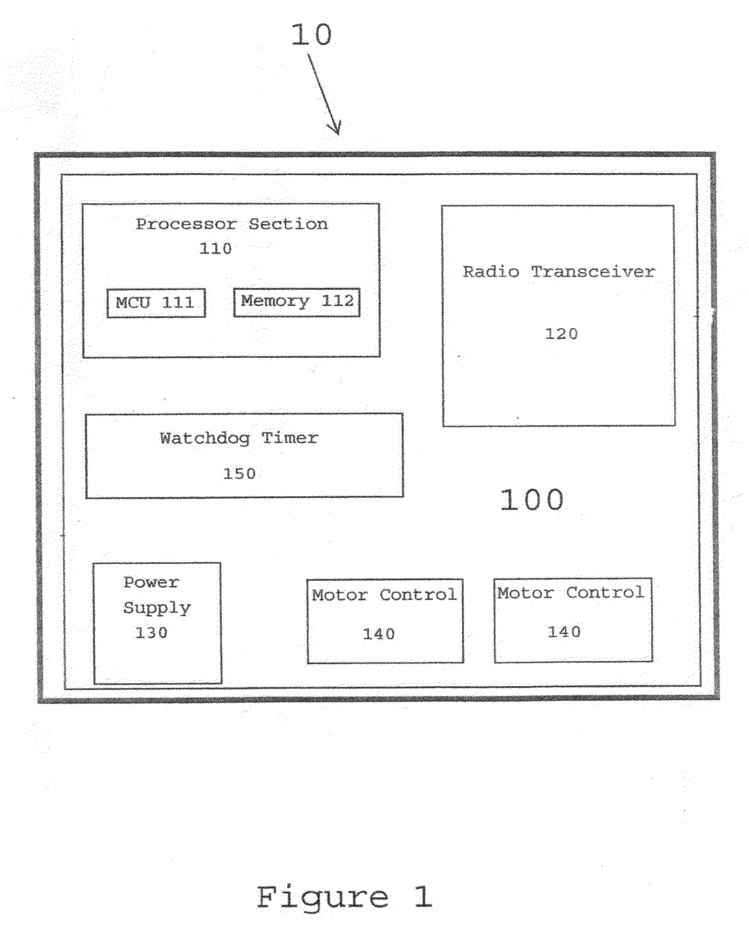

FIG. 1 is a block diagram of an example of an ICAS Actuator Control Module (ACM) according to the invention and more particularly to the control section 100 of the ICAS-ACM. The control section 100 is located within a sealed enclosure for protection against the high humidity, moisture, and heat, as well as caustic chemicals and solvents typically found in a beverage packaging environment during washdown. The control section 100 is comprised of a processor section 110, a network interface in this example, a wireless radio transceiver 120, a motor controller pair 125, and a power supply section 130. The processor section 110 may include a CPU 111, and memory 112 containing the control algorithm. Alternatively; the network interface 120 is separate from the control section 100 and simply attached to the ACM 10. The network interface 120 can be attached using any known attachment means. Furthermore, the network interface 120 can be embedded into the ACM 10 which is the preferred embodiment. In the case of a wireless transceiver, the preferred method of attachment is embedded into the ACM 10.

Communications to and from the ACM(s) 10 are implemented by the network interface 120. When the network interface is a wireless transceiver in a preferred embodiment, the wireless radio transceiver 120 uses an omni-directional wireless radio antenna. The antenna will have a preset radio coverage range. This radio coverage range will be determined by the location of the ACM 10 and size of the conveyor system in which the ACM 10 is deployed. The ACM 10 should be able to transmit information to each of its closest neighboring ICAS ACM(s) 10 in a near instantaneous time. Therefore, the radio coverage range must be long enough to cover at least the neighboring ACM(s) 10 for a single hop broadcast. Communication with non-neighboring wireless ACM(s) 10, i.e., an actuator not working in the same area, may be performed by a multi-hop broadcast. In other words, the communication can relay to a ACM 10 to whom the communication is intended for, by other intermediary ACM(s) 10. The wireless radio transceiver 120 will be able to uni-cast, multicast and broadcast messages. The details of message transport are handled by the network interface and no changes to the ACM or SG are required beyond changing the network interface to implement a difference network interlace.

The power supply section 130 may comprise a wired DC power supply or similar power supply. The power supply section supplies power to the motor controller 140 and the wireless transceiver 120.

Each ACM 10 is assigned a unique identification, known as a short address, to route communication to and from the wireless ACM(s) 10. The unique identification can be any number that is used to distinguish the wireless ACM(s) 10, such as a sequence of the wireless ACM(s) 10 within the conveyor system. In another embodiment of the invention, the unique identification is an EUI address.

One unique identification, is assigned to each ACM 10. The unique identification can be randomly assigned to the ACM(s) 10 or assigned based upon the sequence within the conveyor system. For example, each ACM 10 can include in the memory 112 of the processor section 110 a database of an available range for the short address and assign itself one of the available short addresses within the range.

Alternatively, the ACM 10 can broadcast a request for a short address to the SC designated for assigning the short addresses for that conveyor segment. The SC will assign a short address based upon the database stored in its memory and will transmit the assigned short address to the ACM 10.

A plurality of ACM(s) 10 are deployed or distributed over the length of the conveyor system. These ACM(s) 10 are individually controllable to vary a plurality of properties of the conveyor system including, but not limited to, rail aperture and height adjustment, capper and filler height adjustment, labeler height adjustment and timing screw aperture and height adjustment and so on.

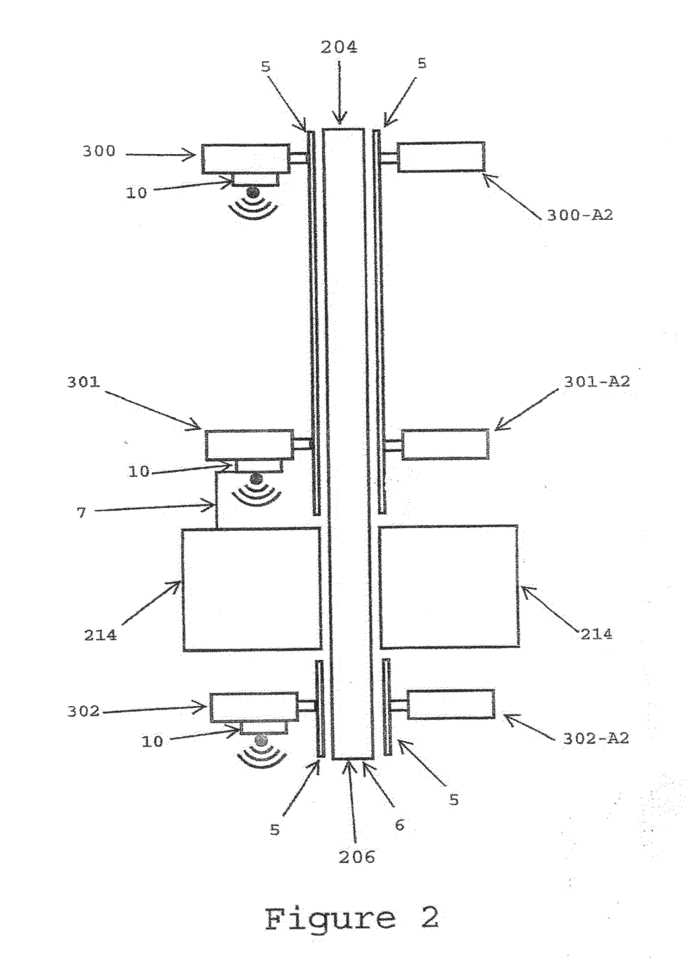

FIG. 2 illustrates an example of a conveyor system with the ACM(s) 10 according to the present invention.

The conveyor system is arranged as an assembly line that extends from a head end 204 containing bottles or packages to a carton of bottled or packaged product 206. In between the head end 204 and the bottled or packaged product 206, a series of rails 5 constrain the bottles or packages and are fed on a conveyor 6 past various Master Actuators (MA) with ACM(s) 10 and Secondary Actuators (SA) that control properties of the rail height and aperture.

Also included in the assembly line are machine(s) 214 (machines can be but not limited to uncase packers, washers, dryer, filler, capper, labeler, inspections scanners, carton erecters, case packers, and any other machines found on a packaging line) that are used in the various operations of packaging products and producing packages. It will be understood that the particular actuators and machines shown in FIG. 2 are for illustrative purposes only and any arrangement of actuators and machines is dependent on the bottles or packages and the goods which are being packaged.

The ACM(s) 10 are in communication with each other via the wireless communications network created by a plurality of ACM(s) 10. In another embodiment, the ACM(s) 10 are also in communication with the machines and in this case a scanner 214. The scanner measure properties from the product being packaged and communicate the measured properties to the supervisory control system via the ACM 10 through a hard wired interface 7.

The wireless communications network is high speed, connecting together the ACM(s) 10 for two-way, peer-to-peer communication between all ACM(s) 10 in the network.

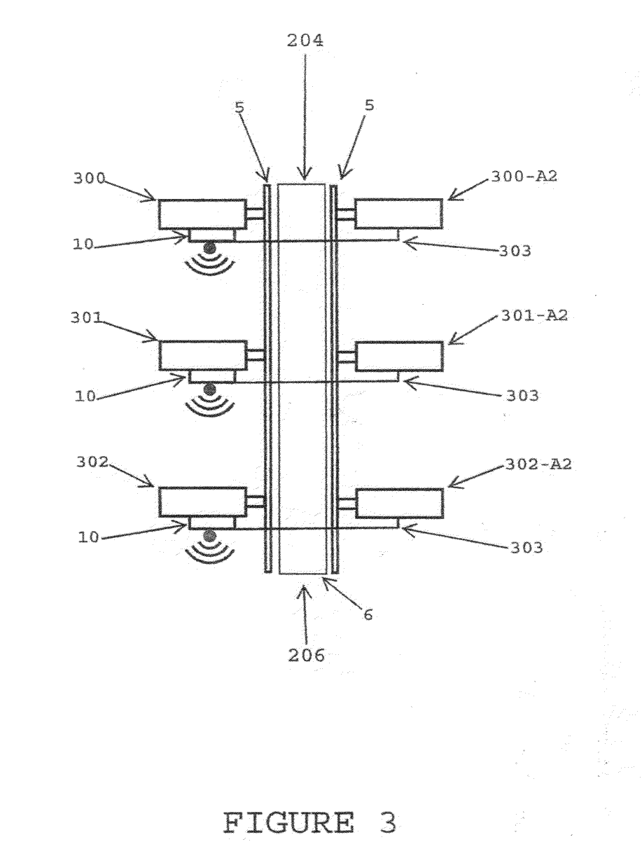

FIG. 3 illustrates three ACMs according to an embodiment of the invention. It will be understood that the particular number of actuators shown in FIG. 3 are for illustrative purposes only and any number of ACM(s) 10 can be used and is dependent on the type of product which is being packaged. Hear again an packaging line with the head of the line where product 214 moves on the conveyor 6 constrained by guide rails 5 to destination at 206. As depicted in FIG. 3 there are three MAs, 300, 301 and 302, where 300 is MA1, 301 is MA 2, and 302 is MA 3. Each MA 300, 301, or 302 has the identical control structure ACM 10 as depicted in FIG. 1 and, therefore, the control structure is not depicted in FIG. 3, except for the wireless radio transceiver. The ACM 10s are electrically connected to a secondary actuators 300-A2, 301-A2 and 302-A2 by a multi-wire electrical cable 303. In one embodiment, the MAs with ACM 10s 300, 301, and 302 are labeled in order to identify the specific actuator. An ACM set consists of 1 to 240 actuators.

Each of the three ACMs of 300, 301, and 302 will periodically broadcast control and functional information or a message to the other ACMs, e.g. 301. The message will include a destination for the message, a time of the broadcast, the control parameters, actuator position or output level, and a status of the sending actuator. Optionally, the message might include the time of the next control and status message. Upon receipt of the message, each receiving ACM, e.g. 300 and 302, will store the received control parameters in its memory 112 and its processor section 110 will re-calculate various operational parameters based upon the received control information. For example, ACM 301 will broadcast a message to ACMs 300 and 302 using its wireless radio transceiver. ACMs 300 and 302 will receive the message via its own wireless radio transceiver 120 and re-calculate the operational parameters.

Each ACM 300 302 will continuously monitor its own performance, using the processor section 110 and broadcast a status alarm if the ACM is not operating as directed. This status alarm can be transmitted to a specific SC or to a group of wireless actuators or to all of the ACMs within the wireless communication network. Additionally, each SC will periodically monitor the performance of the ACMs within its segment. Specifically, each ACM has a watchdog timer 135 or a timing means. The watchdog timer 135 is set to a predetermined time. This predetermined time is determined based upon the expected time that the next control and status message should be received. This time can be obtained directly from a prior control and status message. Alternatively, there is a default time that can be used. The watchdog timer 135 is reset upon receipt of a message. The watchdog timer 135 is a tool that is used to determine if any of the actuators' wireless transceivers 120 malfunction. When the watchdog timer 135 expires, the ACM, for example actuator 301, will broadcast a status inquiry to each other ACM 300 and 302 and the SC whom the ACM 301 expected to receive a control and status message. If a response is not received by the ACM 301 from each of the other ACMs, i.e., 300 and 302, then the ACM 301 will determine that the wireless radio transceiver 120 has malfunctioned. The ACM 301 will then broadcast to all of the other wireless actuators, in the communication network, a message indicating that a wireless radio transceiver 120 has malfunctioned. The message will include the time of the broadcast, the identification, and the location of the ACM that corresponds to the wireless radio transceiver 120 that malfunctioned. Additionally, in another embodiment, the ACM 301 will also broadcast the message to an external host computer.

While the invention has been described such that an ACM 10 can communicate with other ACM(s) 10 and an SC using the wireless radio transceiver 10, it is within the scope of the invention that each ACM 10 and/or SC can communicate with each other and can communicate with other devices outside the peer-to-peer actuator network that are created by a plurality of ACMs 10 utilizing any implemented network interface. For example, the ACMs can communicate with an external host computer and a plurality of machines 214.

The invention can also be designed so that if an ACM has lost communication to the SC it can be connected with a direct temporary wired connection to adjust an actuator. This can also be used to initialize positions of actuators. The actuators can also be designed to have a static state when there is no power to them, use of the Acme screw does this and other things like a properly geared actuator(sometimes the device being adjusted will keep it's own static state, like in the case of many screws being turned). When power and communication is returned they can be queried and will give their current actuator position. This makes it possible that the SC could even put them in a sleep mode to conserve energy.

Further the system will allow for an easier way to adjust rails on a conveyor system by using flexible rails where needed. In existing systems many times at corners whole sections of the guide rail need to be replaced, by using the flexible rails there is no need to take the time to replace a section. By using a flexible material for the rail the actuators allow for various contours on the conveyor system and in some instances allow greater flexibility and better control. One embodiment of the flexible rail system uses strips of spring steel backing the plastic guide rail made out of UHMW or any of a number of commercially available rail materials. This could be nylon or delron or many other materials that are flexible and the packages would move along them. The spring steel may also be preformed to a particular radius so that they can be used where the conveyor will have a similar radius. The steel strips will support the guide rail and will allow for a smooth transition from straight to curved sections or from one curve to another, but allow for changes in the radius when the actuators move in or out. The change in the width between the guide rails on the conveyor system can be controlled by a set of ACMs.

As noted before the ACM can also control another actuator or actuators which would be an ICAS Secondary Actuator (SA), so therefore they could be used in pairs (triplets quads . . . ) but still perform separate movements of the Master and Secondary. They could be used as opposing actuators controlling the width and location of the guide rails above the conveyor. They also could be used as independent actuators on the same side of the conveyor as consecutive actuators controlling the location and shape of the guide rail. Or they could control two axis of the location of a timing screw, in fact a ACM and 3 SA's could position both ends of a timing screw or some other device on a conveyor system. Similarly the ACMs or SAs may have a rotary motion as their actuation motion. This rotary type actuator can be used in various ways. It can be used instead of hand cranks for various adjustments on the line. It could turn a screw and move a component that is held on guides, ways, or slides, etc. It could be used to move a cam or a gear or some other device that needs a rotary action. The rotary ACM or SA could be attached to a housed cable like the push/pull and could transmit the rotary motion from it and could be used to turn a device or a gear that is used to move or control a device on the conveyor system. In another embodiment an ACM can be mounted so that it controls a pivot type lever that controls the location of the rail or some other device on the conveyor system. ACMs and SAs in the ICAS can be controlled to move in many different ways, for example: in unison, sequential, parallel, in a “zipper” function, in groups, one only, or in any technique that is feasible.

CALIBRATION: This system will allow for very accurate adjustments of the conveyor rails, and other devices on a conveyor system, because of this there is a need for accurate calibration of the individual actuators and their relative location to the conveyor or the device they are to position. There could be various ways to calibrate or align the actuators for the rails, but unique to this system we will describe how to use lasers to calibrate the ACMs and SAs on a conveyor system. This laser alignment will position a laser a pair of prisms and a receiver on the conveyor track. The laser will be mounted at the beginning of a straight section at an offset from the center of the track and be pointed to the prism also at the same offset from the center of the track further down on the track or at the end of a straight section. The laser beam will bounce off the first prism or reflector across to the other prism or reflector which is located with the same offset on the other side of center and back to the receiver positioned next to the laser but with the same offset on the other side of center. To make this easy the laser-receiver can be mounted on a self centering truck that is place on the conveyor and the reflectors can also be mounted on another self centering truck. The actuators are then controlled by the SC to move in till they break the laser beam and stop it from being detected by the receivers, they then move back slowly until the beam is detected again. This is done one at a time and gives the SC a precise value for each of the ACMs or SAs. The receiver would be connected to a wireless device similar to the ACM and communicate to the SC and/or the ACM. For calibration of the actuators where a curve or radial section may exist, another laser device could be used. On a self centering truck you would have a laser and a receiver, mounted above the actuator and have them point down to a pair of prisms mounted below the actuator that will reflect the beam across to the other side and back up. This will give a beam on either side of the track that can be broken when the actuator is moved in. The calibration routine will move the actuator on one side in until it breaks the beam and then back slowly till it sees it again and records the position. The other side will be calibrated in the same way. An additional way to calibrate the ACMs or/and SAs could be to use self centering trucks with a digital read out (DRO) scale device. The DRO is connected to the actuator on one side and then the other and are moved until the DRO reads or transmits a desired position. The calibration routine then records that location in a table for that ACM or SA. The DRO device could even be spring loaded so that it would automatically touch against the actuator or rail. It could also have two DRO devices and then take readings on both sides and give readings at any location desired on the conveyor line.

The above description and drawings are given to illustrate and provide examples of various aspects of the invention, and are not intended to limit the invention to the examples or illustrations or to limit the use of the invention. Given the benefit of the above disclosure, those skilled in the art may be able to devise various modifications and alternate constructions that, although differing from the examples disclosed herein, nevertheless enjoy the benefits of the invention and fall within the scope of the invention.

The invention claimed is:

1. An intelligent wireless conveyor actuator system, comprising one or more IWCAS Segment Coordinator(s) (SC) and IWCAS Actuator Control Modules (ACM), using a wireless radio transceiver for transmitting and receiving instructions to actuators on a conveyor system.

2. An ACM of claim 1 which is attached to a guide rail and positions the guide rail according to the instructions from an SC.

3. An ACM of claim 2 that is coupled by electrical cable to another actuator (SA) attached to a guide rail opposing it that it controls the width between it and SA is controlled by signals from a ACM.

4. An ACM of claim 1 comprising: a network interface in the case of a specific embodiment a wireless radio transceiver for transmitting and receiving control and functional information to and from SCs; a control means for processing said received control and functional information and for outputting a control signal to one or more electrical or mechanical devices based upon said received control and functional information; and a memory section for storing said control and functional information, the output signal, and said ACM's own unique communications identifier. Said unique identifier is used to route information to one SC, said ACM is configured for communication to SCs within an actuator network or conveyor system

5. The ACM of claim 2 wherein said network interface, in the case of a specific embodiment a wireless radio transceiver, is configured for uni-casting, multicasting and broadcasting information.

6. The ACM of claim 1 wherein said control and functional information is routed based upon a location of an originating ACM or, alternatively, in a deterministic manner.

7. The SC of claim 1 wherein said memory section further includes a database of all of the ACMs within the conveyor segment, said ACM's corresponding unique communication identifier and said ACM's corresponding position along a conveyor line segment.

8. The ACM of claim 4 further comprising: a timing means that is set to a predetermined threshold value, said predetermined threshold value is based upon a time that said ACM expects to receive said control and functional information from controlling SC units. When said timing means expires without receiving said control and functional information from the controlling SC unit, said ACM will broadcast a status inquiry to at least one neighboring SC or ICAS Supervisory Gateway (SG), and if a response to said status inquiry is not received, said ACM will transmit a communications error message to said other ACMs.

9. The ACM of claim 4 wherein at least one ACM broadcasts an error message to at least one other ACM, said at least one other ACM receives the error message, determines a type of error and transmits the error condition to another SC unit.

10. The ACM of claim 6 wherein said error message is given a higher priority for a communication channel than other periodic control and status messages.

11. The ACM of claim 2 where it moves the guide rail by using a push/pull, cable or flexible strips, to change the position of the rail.

12. The ACM of claim 13 where it moves a pair of push/pull cables to position both sides of a conveyor or multiple positions on a guide rail.

13. An intelligent conveyor actuator system of claims 1 to 12 where feedback information is recorded to calibrate actuators on a conveyor system

14. The ICAS of claim 13 where the calibration routine moves the actuators on the system to obscure a laser beam as a way to give feedback of the position of an actuator or guide rail.

15. The ICAS of claim 13 or 14 where the calibration routine gets feed back from a network interfaced DRO of which a wireless radio transceiver is one of several specific network interfaces that is positioned on the conveyor system.

16. The ICAS of claim 2, where the use of a flexible guide rail is used that has arcs pre-bent to a nominal radius.

17. The ICAS of claim 20 where these pre-bent rails consist of two pieces of spring steal and they have been welded or attached at points to hold the nominal radius.

18. The ICAS of claim 11 where the actuator(s) are used to adjust machine(s) on a packaging line.

19. The ICAS of claim 22 where there are rotary actuators and or Scissor type actuators are used to adjust machine(s) or rails on a conveyor line.

20. The ICAS system which utilizes a mix of network types with-in various areas of the system.

21. The ICAS system of claim 1 where SCs can receive commands and exchange information with identified higher level controllers of the types of Human Machine Interface (HMI), Programmable Controller, Computer System, hand held device, intelligent cell phones.
